(19) United States
(12) Patent Application Publication
(10) Pub. No.: US 2017/0149856 A1
(43) Pub. Date: May 25, 2017

(54) WIRELESS VIDEO TRANSMISSION DEVICE, VIDEO PLAYING DEVICE AND METHOD, AND SYSTEM

(71) Applicants: Le Holdings(Beijing)Co., Ltd., Beijing (CN); LE SHI ZHI XIN ELECTRONIC TECHNOLOGY (TIAN JIN) LIMITED, Tianjin (CN)

(72) Inventor: Wei LIU, Tianjin (CN)

(21) Appl. No.: 15/222,908

(22) Filed: Jul. 28, 2016

Related U.S. Application Data
(63) Continuation of application No. PCT/CN2016/084783, filed on Jun. 3, 2016.

(30) Foreign Application Priority Data
Nov. 20, 2015 (CN) 201510812236.X

(51) Int. Cl. H04L 29/06; H04W 4/00

(52) U.S. Cl. CPC H04L 65/602; H04W 4/008; H04L 65/607; H04W 84/12

(57) ABSTRACT

Embodiments of the disclosure provide a wireless video transmission device and method, video playing device and method, and system. The system includes a wireless video transmission device and a video display device, where the wireless video transmission device includes a video processor, a data compression module, and a wireless transmission module; and the video display device includes a wireless transmission module, a data decompression module, a video processor, and a display screen. In the disclosure, since UHD video data are transmitted after being compressed, and the bandwidth of the compressed UHD video data does not go beyond the bandwidth capacity of a wireless transmission protocol, then the compressed UHD video data can be transmitted using a wireless transmission technology, and further the compressed UHD video data can be decompressed at the video playing device side so that the recovered UHD video can be played normally at the video playing device.

### CROSS REFERENCE TO RELATED APPLICATIONS

This application is a continuation International Application No. PCT/CN2016/084783, filed on May 13, 2016, which claims priority to Chinese Patent Application No. 201510812236.X, filed on Nov. 20, 2015, both of which are hereby incorporated by reference in their entireties.

### TECHNICAL FIELD

The present disclosure relates to the field of video technologies, and particularly to a wireless video transmission device, video playing device and method, and system.

### BACKGROUND

Wireless transmission of videos has been widely applied, and existing wireless technologies for video transmission include 2.4G wireless transmission (Bluetooth, Wireless Fidelity (WIFI), etc.), 5G wireless transmission (WIFI, etc.), 60G wireless transmission (802.11ad, Wireless High Definition (WIHD), etc.), for example.

There is a limited bandwidth capacity of the existing wireless transmission technologies, for example, the bandwidth capacity of WIHD with the highest bandwidth capacity so far is 3 GBps so that it can support video transmission of 1080P@60p, where 1080P@60p indicates that 60 frames are played per second, and the resolution of each frame is 1080P.

Along with the development of video technologies, Ultra High Definition (UHD) videos have been developed and popularized rapidly. The bandwidth of the UHD videos goes beyond the bandwidth capacity of the existing wireless transmission technologies, for example, the bandwidth of a UHD video with 4K2K@30p is approximately 9 Gbps, whereas the bandwidth capacity of WIHD with the highest bandwidth capacity so far is only 3 GBps, so the UHD video (e.g., the 4K2K video) can not be transmitted using the existing wireless transmission technologies.

### SUMMARY

Embodiments of the disclosure provide a wireless video transmission device, video playing device and method, and system so as to address such a problem in the prior art that the UHD video can not be transmitted using the wireless transmission technologies.

An embodiment of the disclosure provides a wireless video transmission device including:

a video processor configured to convert Ultra High Definition (UHD) video data into the data in a format supported by a data compression module, and to transmit the converted UHD video data to the data compression module;

the data compression module configured to compress the converted UHD video data, and to transmit the compressed UHD video data to a wireless transmission module, wherein the bandwidth of the compressed UHD video data to be transmitted does not go beyond a bandwidth capacity of a wireless transmission protocol in which the wireless transmission module operates; and

the wireless transmission module configured to transmit the compressed UHD video data in the wireless transmission protocol.

An embodiment of the disclosure provides a video playing device including:

a wireless transmission module configured to receive compressed UHD video data in a wireless compression protocol, and to transmit the compressed UHD video data to a data decompression module, wherein the bandwidth of the compressed UHD video data to be received does not go beyond a bandwidth capacity of a wireless transmission protocol in which the wireless transmission module operates:

the data decompression module configured to decompress the compressed UHD video data at a preset compression ratio, and to transmit the decompressed UHD video data to a video processor;

the video processor configured to convert the decompressed UHD video data into the data in a playing format supported by a display screen, and to transmit the converted UHD video data to the display screen; and

the display screen configured to display a UHD video according to the converted UHD video data.

An embodiment of the disclosure provides a wireless video transmission method including:

converting Ultra High Definition (UHD) video data into the data in a format supported by a data compression module; and

compressing the converted UHD video data, wherein the bandwidth of the compressed UHD video data to be transmitted does not go beyond a bandwidth capacity of a wireless transmission protocol in which a wireless transmission module operates; and

transmitting the compressed UHD video data in the wireless transmission protocol.

An embodiment of the disclosure provides a video playing method including:

receiving compressed UHD video data in a wireless compression protocol, wherein the bandwidth of the compressed UHD video data to be received does not go beyond a bandwidth capacity of a wireless transmission protocol in which a wireless transmission module operates:

decompressing the compressed UHD video data:

converting the decompressed UHD video data into the data in a playing format supported by a display screen; and

displaying a UHD video according to the converted UHD video data.

An embodiment of the disclosure provides a video wireless-transmission and playing system including:

the wireless video transmission device described above, and the video playing device described above, wherein:

the wireless transmission module in the wireless video transmission device is configured to transmit the compressed UHD video data to the wireless transmission module in the video playing device in the wireless transmission protocol; and

the wireless transmission module in the video playing device is configured to receive the compressed UHD video data transmitted by the wireless transmission module in the wireless video transmission device in the wireless transmission protocol.

With the wireless video transmission device and method, video playing device and method, and system according to the embodiments of the disclosure, since the UHD video data are transmitted after being compressed, and the bandwidth of the compressed UHD video data does not go beyond the bandwidth capacity of the wireless transmission protocol, then the compressed UHD video data can be transmitted using the wireless transmission technology.

Correspondingly, the compressed UHD video data are decompressed at the video playing device side so that the video playing device can play normally the recovered UHD video data.

Thus the technical solutions according to the embodiments of the disclosure enable the UHD video data to be transmitted using the wireless transmission technologies, and to be played.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed

FIG. 1 is a schematic structural diagram of an embodiment of a wireless video transmission device according to the disclosure;

FIG. 2 is a schematic structural diagram of an embodiment of a video playing device according to the disclosure:

FIG. 3 is a schematic structural diagram of an embodiment of a video wireless-transmission and playing system according to the disclosure;

FIG. 4 is a schematic flow chart of an embodiment of a wireless video transmission method according to the disclosure; and

FIG. 5 is a schematic flow chart of an embodiment of a video playing method according to the disclosure.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

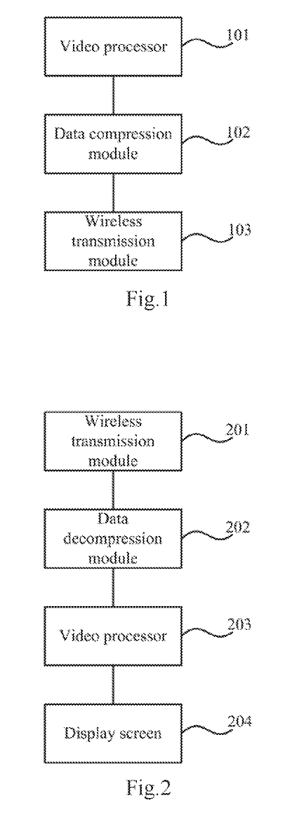

As illustrated in FIG. 1, an embodiment of the disclosure provides a wireless video transmission device including at least:

A video processor 101 is configured to convert Ultra High Definition (UHD) video data into the data in a format supported by a data compression module, and to transmit the converted UHD video data to the data compression module; and

The data compression module 102 is configured to compress the converted UHD video data, and to transmit the compressed UHD video data to a wireless transmission module.

Where the bandwidth of the compressed UHD video data to be transmitted does not go beyond a bandwidth capacity of a wireless transmission protocol in which the wireless transmission module operates; and

The wireless transmission module 103 is configured to transmit the compressed UHD video data in the wireless transmission protocol.

With the wireless video transmission device according to the embodiment of the disclosure, since the UHD video data are transmitted after being compressed, and the bandwidth of the compressed UHD video data does not go beyond the bandwidth capacity of the wireless transmission protocol, then the compressed UHD video data can be transmitted using the wireless transmission technology.

In an implementation, the data compression module 102 can be a Display Stream Compression (DSC) compression unit. In a particular implementation, the DSC compression unit can compress the UHD video data using the DSC compression technology provided by the Video Electronics Standards Association (VESA), and the particular implementation thereof can be adjusted over time to the standards and the protocols published on the website of the VSEA, etc. A particular circuit thereof can be structured as in the prior art, so a detailed description thereof will not be repeated. Since the DSC compression technology can be implemented at a low cost, and it is a visually lossless compression technology, the data compression module can be embodied by the DSC compression unit in the technical solution according to the embodiment of the disclosure to thereby lower the implementation cost, and the performance of the system.

It shall be noted that the DSC compression technology is implemented as an example due to the low implementation cost thereof, so the data compression technology here has been described as the DCS compression technology only by way of an example, but the data compression module can alternatively operate with another compression technology as long as the data compression module compresses the converted UHD video data so that the bandwidth of the compressed UHD video data to be transmitted does not go beyond the bandwidth capacity of the wireless transmission protocol in which the wireless transmission module operates, so the DSC compression technology is merely intended to teach those skilled in the art about how to put the disclosure into practice, but not intended to suggest that only the DSC compression technology be available; and any corresponding compression technology can be applied in an implementation as needed in practice, and the embodiment of the disclosure will not be limited thereto.

Further to any one of the embodiments above of the wireless transmission device, the wireless transmission module can include but will not be limited to any one of a WIFI transmission unit, a Wireless High Definition (WIHD) transmission unit, a Bluetooth transmission unit, and an 802.11ad transmission unit.

Further to any one of the embodiments above of the wireless transmission device, the wireless transmission device can be a set-top box, or can be an intelligent mobile terminal (e.g., a smart phone).

If the wireless transmission device according to the embodiment of the disclosure is a set-top box, then the compressed UHD video data can be transmitted to a video playing device (e.g., a TV set) over an established wireless transmission connection after the wireless transmission connection is established between the set-top box and the video playing device, where the UHD video data can be transmitted by an external video source in real time to the set-top box, e.g., UHD video data transmitted by the external video source in real time to the set-top box over an optic fiber, or the Ethernet, or in another wired mode. The UHD video data can alternatively be pre-stored locally in the set-top box

If the wireless transmission device according to the embodiment of the disclosure is an intelligent mobile terminal, then the compressed UHD video data can be transmitted to a video playing device (e.g., a TV set) over a wireless transmission connection established between the intelligent mobile terminal and the video playing device after the wireless transmission connection is established between them, where the UHD video data can be pre-stored locally in the intelligent mobile terminal. For example, if a user intends to watch the UHD video data stored locally in the intelligent mobile terminal on a large screen, then the user will trigger the intelligent mobile terminal to establish a wireless transmission connection with a video playing device with the large screen, so that the intelligent mobile terminal can transmit the compressed UHD video data to the video playing device for playing. Of course, the UHD video data can alternatively be transmitted by an external video source in real time to the intelligent mobile terminal, e.g., UHD video data transmitted by the external video source in real time to the intelligent mobile terminal over an optic fiber, or the Ethernet, or in another wired mode.

Further to any one of the embodiments above of the wireless transmission device, the data compression module can compress the converted UHD video data at a preset compression ratio, or the data compression module can compress the converted UHD video data according to the bandwidth capacity of the wireless transmission protocol in which the wireless transmission module operates.

The bandwidth of the compressed UHD video data to be transmitted does not go beyond the bandwidth capacity of the wireless transmission protocol in which the wireless transmission module operates, so that the compression ratio is determined by the bandwidth of the UHD video data, and the bandwidth capacity of the wireless transmission protocol.

As illustrated in FIG. 2, an embodiment of the disclosure further provides a video playing device including at least:

A wireless transmission module 201 is configured to receive compressed UHD video data in a wireless compression protocol, and to transmit the compressed UHD video data to a data decompression module.

Where the bandwidth of the compressed UHD video data to be received does not go beyond a bandwidth capacity of a wireless transmission protocol in which the wireless transmission module operates:

In an implementation, the wireless transmission module of the video playing device operates in the same wireless transmission protocol as the wireless transmission module of the video transmission device;

The data decompression module 202 is configured to decompress the compressed UHD video data at a preset compression ratio, and to transmit the decompressed UHD video data to a video processor;

The video processor 203 is configured to convert the decompressed UHD video data into the data in a playing format supported by a display screen, and to transmit the converted UHD video data to the display screen; and

The display screen 204 is configured to display a UHD video according to the converted UHD video data.

With the video playing device according to the embodiment of the disclosure, since the bandwidth of the compressed UHD video data to be received does not go beyond the bandwidth capacity of the wireless transmission protocol, the compressed UHD video data can be transmitted using the existing wireless transmission technology, and further the compressed UHD video data can be decompressed at the video playing device side so that the recovered UHD video can be played normally at the video playing device. Thus the technical solution according to the embodiment of the disclosure enables the UHD video to be played using the wireless transmission technology, and to be played.

In an implementation, the data decompression module 102 can be a DSC decompression unit. In a particular implementation, the DSC decompression unit can decompress the UHD video data using the DSC decompression technology available from the VESA. A particular circuit thereof can be structured as in the prior art, so a detailed description thereof will not be repeated. Since the DSC decompression technology can be implemented at a low cost, and it is a visually lossless decompression technology, the data decompression module can be embodied by the DSC decompression unit in the technical solution according to the embodiment of the disclosure to thereby lower the implementation cost, and the performance of the system.

Further to any one of the embodiments above of the video playing device, the wireless transmission module 201 can include but will not be limited to any one of a WIFI transmission unit, a WIHD transmission unit, a Bluetooth transmission unit, and an 802.11ad transmission unit.

Further to any one of the embodiments above of the video playing device, the video playing device can include but will not be limited to a TV set, or can be another video playing device with a display screen.

Further to any one of the embodiments above of the video playing device, the data decompression module can decompress the compressed UHD video data at a preset compression ratio, or

The data decompression module can decompress the compressed UHD video data according to the bandwidth capacity of the wireless transmission protocol in which the wireless transmission module operates.

In an implementation, the data decompression module can apply the same compression ratio as the data compression module of the wireless transmission device, and the compression ratio can be prescribed.

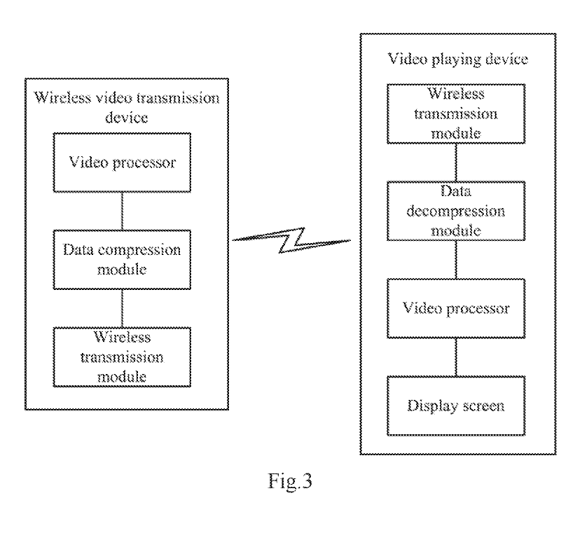

As illustrated in FIG. 3, an embodiment of the disclosure provides a video wireless-transmission and playing system including the wireless transmission device according to any one of the embodiments above, and the video playing device according to any one of the embodiments above.

An example will be described below.

In an application scenario, for example, the wireless transmission device is a set-top box, and the video playing device is a TV set.

In a particular implementation, the set-top box includes at least: a video source interface configured to accept UHD video data; a video processor configured to convert the UHD video data into the data in a format supported by a data compression module, and to transmit the converted UHD video data to a DSC compression unit; the DSC compression unit configured to compress the converted UHD video data at a preset compression ratio; and a WIHD transmission unit configured to transmit the compressed UHD video data in the WIHD transmission protocol.

Here the TV set includes at least: a WIHD transmission unit configured to receive the compressed UHD video data in the WIHD transmission protocol; a DSC decompression unit configured to decompress the compressed UHD video data at a preset compression ratio; a video processor configured to convert the decompressed UHD video data into the data in a playing format supported by a display screen, and to transmit the converted UHD video data to the display screen; and the display screen configured to display a UHD video according to the converted UHD video data.

In the embodiment above, the UHD video accepted by the set-top box can be transmitted wirelessly to and displayed on the display screen of the TV set in real time.

In another example, in another application scenario, the wireless transmission device is a smart phone, and the video playing device is a TV set.

In a particular implementation, the smart phone includes at least: a memory in which UHD video data are stored; a video processor configured to convent the UHD video data into the data in a format supported by a data compression module, and to transmit the converted UHD video data to a DSC compression unit; the DSC compression unit configured to compress the converted UHD video data at a preset compression ratio; and a Bluetooth transmission unit configured to transmit the compressed UHD video data in the Bluetooth transmission protocol.

Here the TV set includes at least: a Bluetooth transmission unit configured to receive the compressed UHD video data in the Bluetooth transmission protocol; a DSC decompression unit configured to decompress the compressed UHD video data at a preset compression ratio; a video processor configured to convert the decompressed UHD video data into the data in a playing format supported by a display screen, and to transmit the converted UHD video data to the display screen; and the display screen configured to display a UHD video according to the converted UHD video data.

In the embodiment above, the UHD video data stored in the smart phone can be transmitted wirelessly to and displayed on the display screen of the TV set in real time.

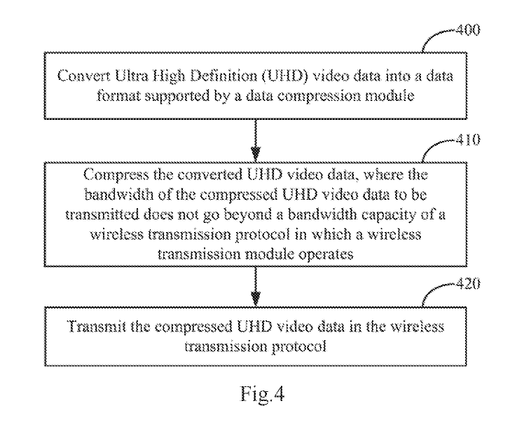

As illustrated in FIG. 4, an embodiment of the disclosure further provides a wireless video transmission method including the following steps:

The step 400 is to convert Ultra High Definition (UHD) video data into the data in a format supported by a data compression module; and

The step 410 is to compress the converted UHD video data, where the bandwidth of the compressed UHD video data to be transmitted does not go beyond a bandwidth capacity of a wireless transmission protocol in which a wireless transmission module operates; and

The step 420 is to transmit the compressed UHD video data in the wireless transmission protocol.

With the wireless video transmission method according to the embodiment of the disclosure, since the UHD video data are transmitted after being compressed so that the bandwidth of the compressed UHD video data does not go beyond the bandwidth capacity of the wireless transmission protocol, the compressed UHD video data can be transmitted using the wireless transmission technology.

Reference can be made to the description of the embodiment of the wireless transmission device above for a particular implementation of the method, so a repeated description thereof will be omitted here.

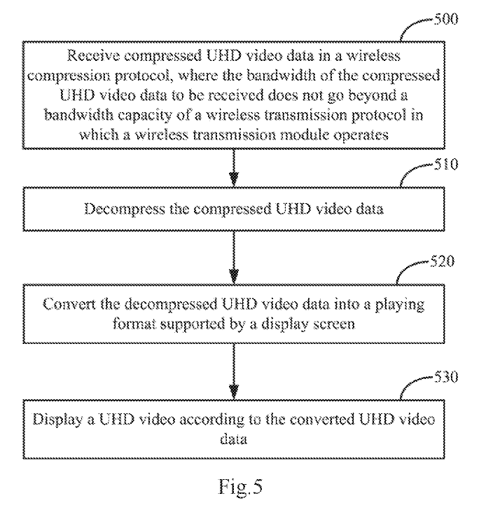

As illustrated in FIG. 5, an embodiment of the disclosure further provides a video playing method including the following steps:

The step 500 is to receive compressed UHD video data in a wireless compression protocol, where the bandwidth of the compressed UHD video data to be received does not go beyond a bandwidth capacity of a wireless transmission protocol in which a wireless transmission module operates:

The step 510 is to decompress the compressed UHD video data;

The step 520 is to convert the decompressed UHD video data into the data in a playing format supported by a display screen; and

The step 530 is to display a UHD video according to the converted UHD video data.

With the video playing method according to the embodiment of the disclosure, since the bandwidth of the compressed UHD video data to be received does not go beyond the bandwidth capacity of the wireless transmission protocol, the compressed UHD video data can be transmitted using the existing wireless transmission technology, and further the compressed UHD video data can be decompressed at the video playing device side so that the recovered UHD video can be played normally. Thus the technical solution according to the embodiment of the disclosure enables the UHD video to be played using the wireless transmission technology, and to be played.

Reference can be made to the description of the embodiment of the video playing device above for a particular implementation of the method, so a repeated description thereof will be omitted here.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure. This can be understood and practiced by those ordinarily skilled in the art without any inventive effort.

Those ordinarily skilled in the art can appreciate that all or a part of the steps in the methods according to the embodiments described above can be performed by program instructing relevant hardware, where the programs can be stored in a computer readable storage medium, and the programs can perform one or a combination of the steps in the embodiments of the method upon being executed; and the storage medium includes an ROM, an RAM, a magnetic disc, an optical disk, or any other medium which can store program codes.

Lastly, it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claim is:

1. A wireless video transmission device, comprising:
a video processor configured to convert Ultra High Definition (UHD) video data into the data in a format supported by a data compression module, and to transmit the converted UHD video data to the data compression module;
the data compression module configured to compress the converted UHD video data, and to transmit the compressed UHD video data to a wireless transmission module, wherein the bandwidth of the compressed UHD video data to be transmitted does not go beyond a bandwidth capacity of a wireless transmission protocol in which the wireless transmission module operates; and
the wireless transmission module configured to transmit the compressed UHD video data in the wireless transmission protocol.

2. The wireless video transmission device according to claim 1, wherein the data compression module is a Display Stream Compression (DSC) compression unit.

3. The wireless video transmission device according to claim 1, wherein the wireless transmission module is any one of a Wireless Fidelity (WIFI) transmission unit, a Wireless High Definition (WIHD) transmission unit, a Bluetooth transmission unit, and an 802.11ad transmission unit.

4. The wireless video transmission device according to claim 1, wherein the wireless video transmission device is a set-top box, or the wireless video transmission device is an intelligent mobile terminal.

5. The wireless video transmission device according to claim 1, wherein the data compression module compresses the converted UHD video data at a preset compression ratio, or
the data compression module compresses the converted UHD video data according to the bandwidth capacity of the wireless transmission protocol in which the wireless transmission module operates.

6. A video playing device, comprising:
a wireless transmission module configured to receive compressed UHD video data in a wireless compression protocol, and to transmit the compressed UHD video data to a data decompression module, wherein the bandwidth of the compressed UHD video data to be received does not go beyond a bandwidth capacity of a wireless transmission protocol in which the wireless transmission module operates;
the data decompression module configured to decompress the compressed UHD video data, and to transmit the decompressed UHD video data to a video processor;
the video processor configured to convert the decompressed UHD video data into the data in a playing format supported by a display screen, and to transmit the converted UHD video data to the display screen; and
the display screen configured to display a UHD video according to the converted UHD video data.

7. The video playing device according to claim 6, wherein the data decompression module is a DSC decompression unit.

8. The video playing device according to claim 6, wherein the wireless transmission module is any one of a WIFI transmission unit, a Wireless High Definition (WIHD) transmission unit, a Bluetooth transmission unit, and an 802.11ad transmission unit.

9. The video playing device according to claim 6, wherein the video playing device is a TV set.

10. The video playing device according to claim 6, wherein the data decompression module is configured to decompress the compressed UHD video data at a preset compression ratio, or
the data decompression module is configured to decompress the compressed UHD video data according to the bandwidth capacity of the wireless transmission protocol in which the wireless transmission module operates.

11. A wireless video transmission method, comprising:
converting Ultra High Definition (UHD) video data into the data in a format supported by a data compression module; and
compressing the converted UHD video data, wherein the bandwidth of the compressed UHD video data to be transmitted does not go beyond a bandwidth capacity of a wireless transmission protocol in which a wireless transmission module operates; and
transmitting the compressed UHD video data in the wireless transmission protocol.

12. A video playing method, comprising:
receiving compressed UHD video data in a wireless compression protocol, wherein the bandwidth of the compressed UHD video data to be received does not go beyond a bandwidth capacity of a wireless transmission protocol in which a wireless transmission module operates;
decompressing the compressed UHD video data;
converting the decompressed UHD video data into the data in a playing format supported by a display screen; and
displaying a UHD video according to the converted UHD video data.

13. A video wireless-transmission and playing system including the wireless video transmission device according to claim 1, and further including a video playing device that includes:
a wireless transmission module configured to receive compressed UHD video data in a wireless compression protocol, and to transmit the compressed UHD video data to a data decompression module, wherein the bandwidth of the compressed UHD video data to be received does not go beyond a bandwidth capacity of a wireless transmission protocol in which the wireless transmission module operates,
the data decompression module configured to decompress the compressed UHD video data, and to transmit the decompressed UHD video data to a video processor, and
the video processor configured to convert the decompressed UHD video data into the data in a playing format supported by a display screen, and to transmit the converted UHD video data to the display screen, and
the display screen configured to display a UHD video according to the converted UHD video data, wherein:
the wireless transmission module in the wireless video transmission device is configured to transmit the compressed UHD video data to the wireless transmission module in the video playing device in the wireless transmission protocol: and
the wireless transmission module in the video playing device is configured to receive the compressed UHD video data transmitted by the wireless transmission module in the wireless video transmission device in the wireless transmission protocol.
